(19) United States
(12) Patent Application Publication
(10) Pub. No.: US 2020/0090129 A1
(43) Pub. Date: Mar. 19, 2020

(54) METHODS, SYSTEMS, APPARATUSES AND DEVICES FOR FACILITATING MANAGEMENT OF EMPLOYEE DATA

(71) Applicant: Calix Leigh-Reign, Lancaster, CA (US)

(72) Inventor: Calix Leigh-Reign, Lancaster, CA (US)

(21) Appl. No.: 16/398,970

(22) Filed: Apr. 30, 2019

Related U.S. Application Data
(60) Provisional application No. 62/732,921, filed on Sep. 18, 2018.

(51) Int. Cl. G06Q 10/10; G06F 16/2457; G06Q 10/06

(52) U.S. Cl. CPC G06Q 10/105; G06F 16/27; G06Q 10/063; G06F 16/2457

(57) ABSTRACT

Disclosed herein is a method of facilitating management of employee data, in accordance with some embodiments. Accordingly, the method may include receiving, using a communication device, a log in request from at least one employee device. Further, the method may include receiving, using the communication device, employee data associated with at least one employee from the at least one employee device. Further, the method may include validating, using a processing device, the employee data by using data retrieved from one or more databases. Further, the one or more databases may include at least one of government verified databases, educational institution databases, and medical databases. Further, the method may include storing, using a storage device, the employee data in an employee database based on the validating.

### TECHNICAL FIELD

Generally, the present disclosure relates to the field of data processing. More specifically, the present disclosure relates to methods, systems, apparatuses and devices for facilitating management of employee data.

### BACKGROUND

Currently, employers face a huge challenge of solving the issue of manipulated work experiences of the job applicants they shortlist. In the present scenario, there is currently no electronic universal employee verification system in place that allows prospective employers the ability to conveniently cross-reference their applicant's prior employment experiences and reduce employer risk of making uninformed decisions. Further, there is no verified record of applicant's work histories, improving an applicant's chances to exaggerate or omit job experiences when applying for new jobs. There is a need to maintain a comprehensive database of work experiences, that is to be shared among employers.

Employers have a challenging task of verifying applicant references utilizing the only methods available to them (phone, email, mail), which are inefficient processes and are a waste of resources and time.

Therefore, there is a need for improved methods, systems, apparatuses and devices for facilitating management of employee data that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating management of employee data, in accordance with some embodiments. Accordingly, the method may include receiving, using a communication device, a log in request from at least one employee device. Further, the method may include receiving, using the communication device, employee data associated with at least one employee from the at least one employee device. Further, the method may include validating, using a processing device, the employee data by using data retrieved from one or more databases. Further, the one or more databases may include at least one of government verified databases, educational institution databases, and medical databases. Further, the method may include storing, using a storage device, the employee data in an employee database based on the validating.

Further disclosed herein is a system of facilitating management of employee data, in accordance with some embodiments. Accordingly, the system may include a communication device configured for receiving a log in request from at least one employee device. Further, the communication device may be configured for receiving employee data associated with at least one employee from the at least one employee device. Further, the system may include a processing device configured for validating the employee data by using data retrieved from one or more databases. Further, the one or more databases may include at least one of government verified databases, educational institution databases, and medical databases. Further, the system may include a storage device configured for storing the employee data in an employee database based on the validating.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram representation of a system of facilitating management of employee data, in accordance with some embodiments.

FIG. 3 is a flowchart of a method of facilitating management of employee data, in accordance with some embodiments.

FIG. 4 is a flowchart of a method to facilitate the validating of an employee data, in accordance with some embodiments.

FIG. 5 is a flowchart of a method to facilitate accessing employee data, in accordance with some embodiments.

FIG. 6 is a flowchart of a method to facilitate accessing employee data based on blockchain, in accordance with further embodiments.

FIG. 7 is a flowchart of a method to facilitate updating employee data on an employee database, in accordance with some embodiments.

FIG. 8 is a flowchart of a method to facilitate providing insights based on employee data, in accordance with some embodiments.

FIG. 9 is a flowchart of a method to validate and store employee details, in accordance with some embodiments.

FIG. 10 is a flowchart of a method to facilitate providing results for a search query about an applicant, in accordance with some embodiments.

FIG. 11 is a flowchart of a method for updating existing employee record, in accordance with some embodiments.

FIG. 12 is a process facilitating management of employee data, in accordance with some embodiments.

FIG. 13 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of management of employee data, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

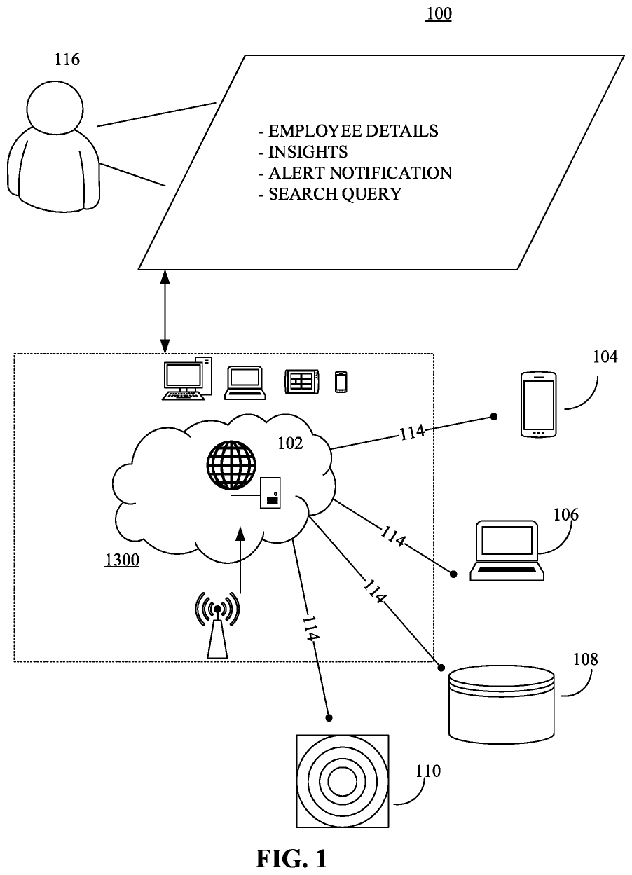

FIG. 1 is an illustration of an online platform 100 consistent with various embodiments of the present disclosure. By way of non-limiting example, the online platform 100 to facilitate management of employee data may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 1300.

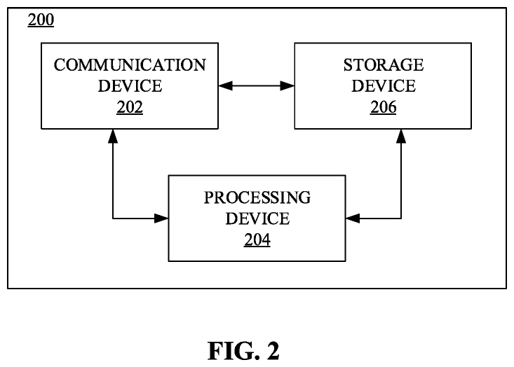

FIG. 2 is a block diagram representation of a system 200 of facilitating management of employee data, in accordance with some embodiments. Accordingly, the management of employee data, in an instance, may include sharing, searching, and/or verification of employee data. Further, the system 200 may include a communication device 202 configured for receiving a log in request from at least one employee device. Further, the log in request, in an instance, may include credentials that may be used to identify if the user may be an authorized user (e.g. a user registered with the online platform 100). Further, the log in request, in an instance, may include credentials such as a company name, an employer name, an employer ID, an email id, a password, a contact number and so on. Further, the log in request, in an instance, may also include parameters such as (but not limited to) area of expertise of company, area of operation of working, number of sub-branches, location of offices. Further, the at least one employee device, in an instance, may be a user device that may be operated by an employee in order to communicate the system. Further, the at least one employee device, in an instance, may include IoT based device such as (but not limited to) a smartphone, a smartwatch, a tablet, a desktop, a laptop, and so on.

Further, the communication device 202 may be configured for receiving employee data associated with at least one employee from the at least one employee device. In some embodiments, the employee data may include one or more of personal details, professional details, and miscellaneous details associated with the at least one employee. Further, in some embodiments, the personal details may include information such as (but not limited to) employee's last name, employee's first name, employee's date of birth, employee's employee ID number, employee's aliases (if any), and so on. Further, in some embodiments, the professional details may include information such as (but not limited to) employee's dates of job assignment, employee's responsibilities at the previous job, location of job assignment, profile of the job, leadership and management skills of the employee and so on. Further, in some embodiments, the miscellaneous details may include information such as (but not limited to) terms of separation, eligibility of employee for re-hire, notification for resignations by employee, dedication of employee, satisfactory attendance and so on.

Further, the system 200 may include a processing device 204 configured for validating the employee data by using data retrieved from one or more databases. Further, the one or more databases may include at least one of government verified databases (such as, but not limited to, Department of Motor Vehicles), educational institution databases, and medical databases (e.g. Electronic Health Records).

Further, the system 200 may include a storage device 206 configured for storing the employee data in an employee database based on the validating. Accordingly, the employee database, in an instance, may be a database that may be configured to store the employee data in an organized form, which may be accessed electronically from the at least one employee device.

In some embodiments, the storage device 206 may be further configured for retrieving at least one relevant data associated with the at least one employee from the one or more databases. Further, the at least one relevant data, in an instance, may be any information (stored in the one or more databases) associated with the at least one employee, which may be of something of interest with regard to validating the employee data. For instance, the at least one relevant data may include personal detail (such as date of birth) of an employee, which may be retrieved from a hospital database associated with the employee. Further, the processing device 204 may be configured for comparing the at least one relevant data with the employee data to determine at least one of a match and a discrepancy. For instance, if the at least one relevant data (e.g. date of birth) matches with the employee data provided with by employee, then the employee data may be considered to be valid. Further, in another instance, if the at least one relevant data (e.g. job experience) does not match (or a discrepancy is observed) with the employee data provided with by employee, then the employee data may be considered to be invalid. In some embodiments, the communication device 202 may be further configured for transmitting an alert notification to at least one administrator device if the discrepancy may be determined. Further, in some embodiments, the alert notification may include alert (but not limited to) an email, an SMS, a voice call, a voicemail, and an audible alert. Further, the at least one administrator device, in an instance, may be an IoT based device which may be operated by an organization, an administrator, and/or an individual (e.g. a human resource manager) that may be authorized to take corresponding actions. For instance, a human resource manager associated with a company may be notified with the alert notification (such as an email) about the discrepancy in the employee data (such as job experience) provided by an employee. Further, the at least one administrator device, in an instance, may include devices such as (but not limited to) smartphones, smartwatches, PCs, laptops, desktops, tablets, and so on.

In some embodiments, the communication device 202 may be configured for receiving a search query from at least one accessing device to access the employee data. Further, the search query, in an instance, may be any query from a concerned authority (such as, but not limited to, an employee, a human resource manager, and so on) that may wish to access the employee data through the at least one accessing device. Further, the at least one accessing device, in an instance, may include devices such as (but not limited to) smartphones, smartwatches, PCs, laptops, desktops, tablets, and so on.

Further, the communication device 202 may be configured for transmitting the employee data to the at least one accessing device. Further, the storage device 206 may be configured for retrieving the employee data from the employee database based on the search query.

In some embodiments, the storage device 206 may be further configured for storing the employee data on blockchain based on the validating. In some embodiments, the communication device 202 may be configured for receiving a search query from at least one accessing device to access the employee data. Further, the search query, in an instance, may be any query from a concerned authority (such as, but not limited to, an employee, a human resource manager, and so on) that may wish to access the employee data through the at least one accessing device. Further, the at least one accessing device, in an instance, may include devices such as (but not limited to) smartphones, smartwatches, PCs, laptops, desktops, tablets, and so on. Further, the communication device 202 may be configured for transmitting the employee data to the at least one accessing device. Further, the storage device 206 may be configured for retrieving the employee data from the blockchain based on the search query.

In some embodiments, the communication device 202 may be further configured for receiving an updated employee data associated with the at least one employee from the at least one employee device. Further, the updated employee data, in an instance, may be new information associated with the at least one employee that may need to be added and/or updated in the employee database. Further, the processing device 204 may be configured for validating the updated employee data by using data retrieved from the one or more databases. Further, the processing device 204 may be configured for updating the employee database with the updated employee data based on the validating.

In some embodiments, the processing device 204 may be configured for analyzing the employee data stored in the database. Further, the processing device 204 may be configured for generating insights based on the analyzing. Further, in some embodiments, the insights may include at least one of a cost per hire (CPH), a cost of turnover, a time to fill up a position, and an HR expense factor. Further, the communication device 202 may be configured for transmitting the insights to at least one administrator device.

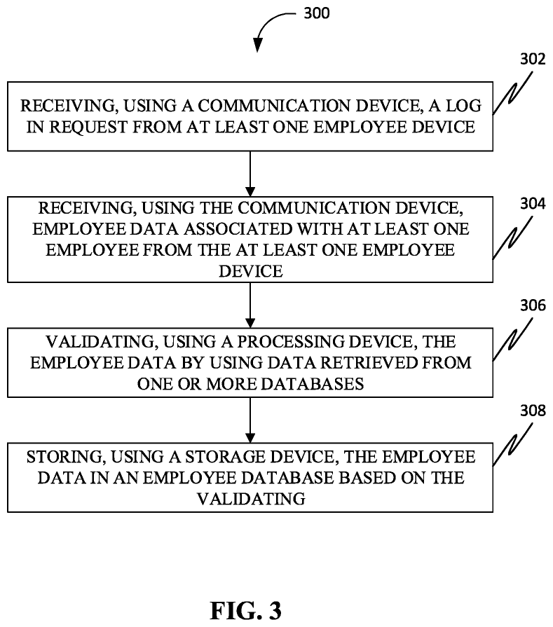

FIG. 3 is a flowchart of a method 300 of facilitating management of employee data, in accordance with some embodiments. Accordingly, at 302, the method 300 may include receiving, using a communication device (such as the communication device 202), a log in request from at least one employee device.

Further, at 304, the method 300 may include receiving, using the communication device, employee data associated with at least one employee from the at least one employee device. In some embodiments, the employee data may include one or more of personal details, professional details, and miscellaneous details associated with the at least one employee. Further, in some embodiments, the personal details may include information such as (but not limited to) employee's last name, employee's first name, employee's date of birth, employee's employee ID number, employee's aliases (if any), and so on. Further, in some embodiments, the professional details may include information such as (but not limited to) employee's dates of job assignment, employee's responsibilities at the previous job, location of job assignment, profile of the job, leadership and management skills of the employee and so on. Further, in some embodiments, the miscellaneous details may include information such as (but not limited to) terms of separation, eligibility of employee for re-hire, notification for resignations by employee, dedication of employee, satisfactory attendance and so on.

Further, at 306, the method 300 may include validating, using a processing device (such as the processing device 204), the employee data by using data retrieved from one or more databases. Further, the one or more databases may include at least one of government verified databases, educational institution databases, and medical databases (e.g. Electronic Health Records).

Further, at 308, the method 300 may include storing, using a storage device (such as the storage device 206), the employee data in an employee database based on the validating.

In further embodiments, the method 300 may include storing, using the storage device, the employee data on blockchain based on the validating.

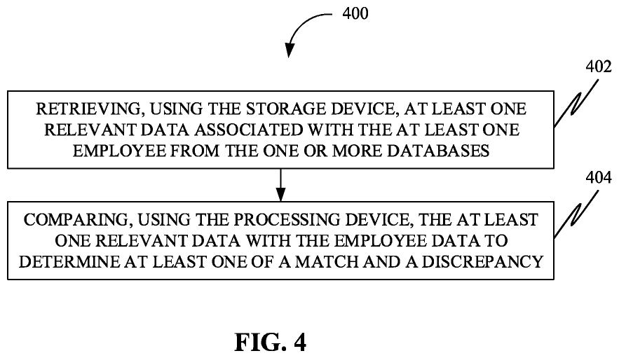

FIG. 4 is a flowchart of a method 400 to facilitate the validating of the employee data, in accordance with some embodiments. Further, at 402, the method 400 may include retrieving, using the storage device, at least one relevant data associated with the at least one employee from the one or more databases.

Further, at 404, the method 400 may include comparing, using the processing device, the at least one relevant data with the employee data to determine at least one of a match and a discrepancy. In some embodiments, the method 400 may further include transmitting, using the communication device, an alert notification to at least one administrator device if the discrepancy may be determined. Further, in some embodiments, the alert notification may include alert (but not limited to) an email, an SMS, a voice call, a voicemail, and an audible alert. Further, the at least one administrator device, in an instance, may be an IoT based device which may be operated by an organization, an administrator, and/or an individual (e.g. a human resource manager) that may be authorized to take corresponding actions. For instance, a human resource manager associated with a company may be notified with the alert notification (such as an email) about the discrepancy in the employee data (such as job experience) provided by an employee. Further, the at least one administrator device, in an instance, may include devices such as (but not limited to) smartphones, smartwatches, PCs, laptops, desktops, tablets, and so on.

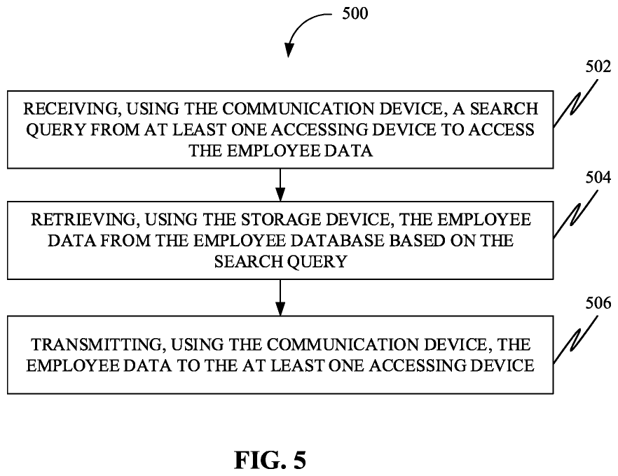

FIG. 5 is a flowchart of a method 500 to facilitate accessing employee data, in accordance with some embodiments. Accordingly, at 502, the method 500 may include receiving, using the communication device, a search query from at least one accessing device to access the employee data.

Further, at 504, the method 500 may include retrieving, using the storage device, the employee data from the employee database based on the search query.

Further, at 506, the method 500 may include transmitting, using the communication device, the employee data to the at least one accessing device.

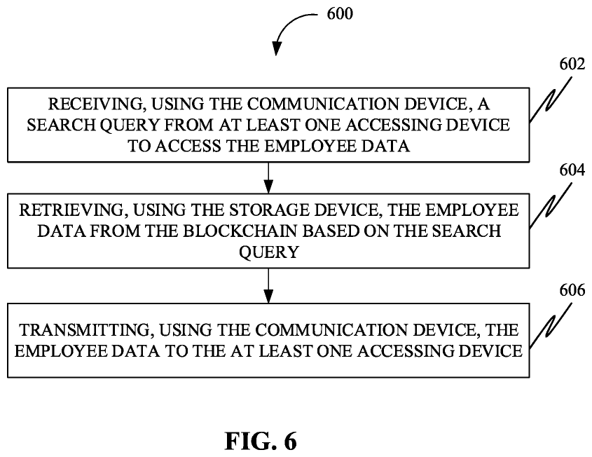

FIG. 6 is a flowchart of a method 600 to facilitate accessing the employee data based on blockchain, in accordance with further embodiments. Accordingly, at 602, the method 600 may include receiving, using the communication device, a search query from at least one accessing device to access the employee data.

Further, at 604, the method 600 may include retrieving, using the storage device, the employee data from the blockchain based on the search query.

Further, at 606, the method 600 may include transmitting, using the communication device, the employee data to the at least one accessing device.

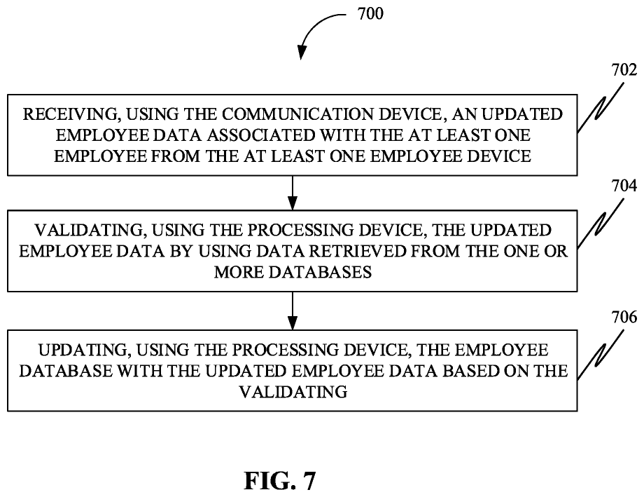

FIG. 7 is a flowchart of a method 700 to facilitate updating employee data on employee database, in accordance with some embodiments. Accordingly, at 702, the method 700 may include receiving, using the communication device, an updated employee data associated with the at least one employee from the at least one employee device.

Further, at 704, the method 700 may include validating, using the processing device, the updated employee data by using data retrieved from the one or more databases.

Further, at 706, the method 700 may include updating, using the processing device, the employee database with the updated employee data based on the validating.

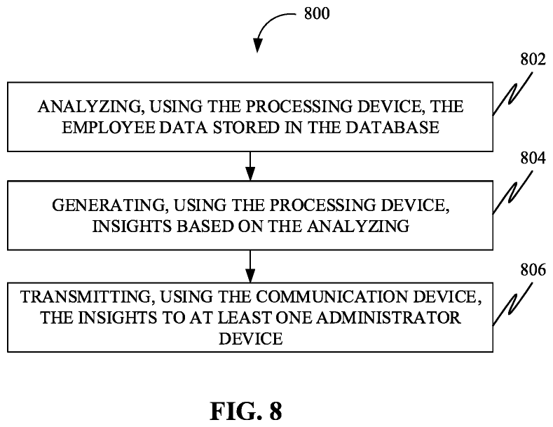

FIG. 8 is a flowchart of a method 800 to facilitate providing insights based on the employee data, in accordance with some embodiments. Accordingly, at 802, the method 800 may include analyzing, using the processing device, the employee data stored in the database.

Further, at 804, the method 800 may include generating, using the processing device, insights based on the analyzing. In some embodiments, the insights may include at least one of a cost per hire (CPH), a cost of turnover, a time to fill up a position, and an HR expense factor.

Further, at 806, the method 800 may include transmitting, using the communication device, the insights to at least one administrator device.

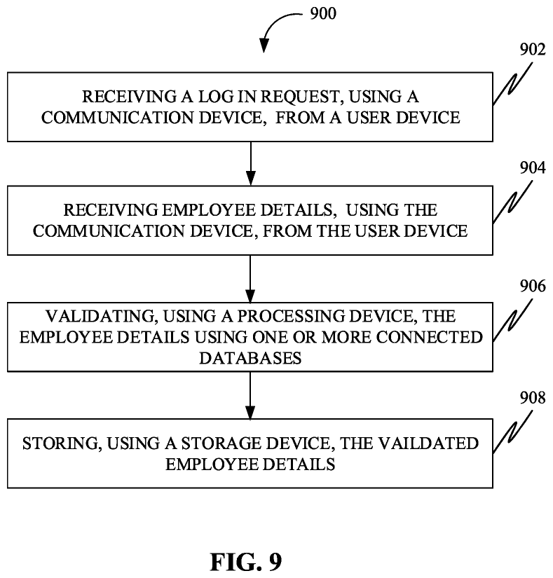

FIG. 9 is a flowchart of a method 900 to validate and store employee details, in accordance with some embodiments. Accordingly, at 902, the method 900 may include a step of receiving, using a communication device, a log in request, from a user device. Further, the log in request may include credentials such as a company name, an employer name, an employer ID, an email id, a password, a contact number and so on. The log in request may also include parameters such as area of expertise of company, area of operation of working, number of sub-branches, location of offices. Further, the log in request may be received from a user device like an electronic computing device such as a smartphone, a tablet, a desktop, a laptop, though other devices may be used too.

Further, at 904, the method 900 may include a step of receiving employee details using the communication device from the user device. Further, the employee details may include personal details of the employee containing the information such as employee's last name, employee's first name, employee's date of birth, employee's employee ID number, employee's aliases (if any), and so on. Further, the employee details may include professional details containing the information such as employee's dates of job assignment, employee's responsibilities at the previous job, location of job assignment, profile of the job, leadership and management skills of the employee and so on. Further, the employee details may include other miscellaneous details such as terms of separation, eligibility of employee for re-hire, notification for resignations by employee, dedication of employee, satisfactory attendance and so on. Further, the employee details may include optional brief review of employee performance.

Further, at 906, the method 900 may include a step of validating, using a processing device, the employee details using one or more connected databases. Further, the validation may include verification of employee details such as employee name, employee date of birth, educational qualifications and certifications, medical history and so on. The employee details may be validated by comparing against information present in or more connected databases such as government verified databases, like Department of Motor Vehicles (DMV), databases maintained by one or more specified education institutes corresponding to the employee, medical institutions databases and so on. Accordingly, information retrieved from the one or more connected databases may be compared against the employee details for validation. Further, in an embodiment, if any discrepancy or false data is found then an alert may be generated, and employer may be informed.

Further, at 908, the method 900 may include a step of storing, using a storage device, the validated employee details. Further, the information input by the employer, if validated positively may be stored in an online universally accessible database, which may be accessed by one or more other employers for verification purposes.

Further, in one embodiment, to clinch data security, block chain technology may be used to ensure the integrity of the data against malicious updates.

Further, in one embodiment, analysis may include analytics on the data stored in the database carried out for a particular domain such as a company, an industry, a state and so on. Further, analytics on data may include Cost per Hire (CPH), which is an aspect of employee analytics that measures the associated costs of sourcing, recruiting, and staffing. Hiring Sources may find out what channels produce the best quality of hires with the lowest possible cost. Cost of Turnover may include a total amount an organization invests in an employee that get lost when said employee decides to leave your company. Time to fill up the open position may include a total number days to fill an opening for each job. HR expense factor may include a ratio between total company expense and HR expense.

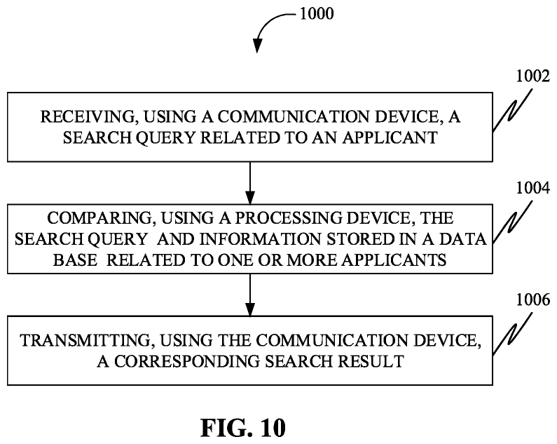

FIG. 10 is a flowchart of a method 1000 to facilitate providing results for a search query about an applicant, in accordance with some embodiments. Accordingly, at 1002, the method 1000 may include a step of receiving, using a communication device, a search query related to an applicant. Further, the search query may be received from an input by the user such as an employer, a concerned authority, and so on, using an electronic computing device such as a smartphone, a tablet, a desktop, a laptop, though other devices may be used too. Further, the search query may include personal details of the applicant's, containing the information such as applicant's last name, applicant's first name, applicant's date of birth, applicant's aliases (if any), and so on. Further, the search query may be for verifying the personal details of the applicant containing the information such as applicant's last name, applicant's first name, applicant's date of birth, applicant's aliases (if any), and so on. Further, the search query may include applicant's professional details containing the information such as applicant's dates of job assignment, applicant's responsibilities held at the previous places of work, location of job assignment, profile of the job, leadership and management skills of the applicant and so on. Further, the applicant details may include other miscellaneous details such as terms of separation, eligibility of applicant for re-hire, notification for resignations by applicant, dedication of applicant, satisfactory attendance and so on. Further, the applicant details may include optional brief review of applicant performance

Further, at 1004, the method 1000 may include a step of comparing, using a processing device, the search query with information stored in a database, related to one or more applicants. Further, the search may be initiated by input of the applicant's full name, applicant's date of birth or other personal details of the applicant from the user device. Further, if the match is found, then the information stored in the database against the matched input is made accessible to the user device.

Further, at 1006, the method 1000 may include a step of transmitting, using the communication device, a corresponding search result. Further, the corresponding search result may be transmitted to the user using one or more of the email, text message, fax and so on.

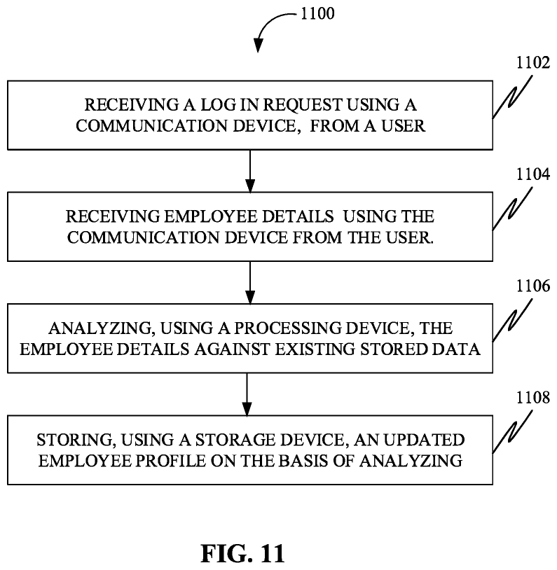

FIG. 11 is a flowchart of a method 1100 for updating existing employee record, in accordance with some embodiments. Accordingly, at 1102, the method 1100 may include a step of receiving a log in request using a communication device, from a user device. Further, the log in request may include credentials such as a Company name, an employer name, an employer ID, an email ID, a password, a contact number and so on. The log in request may also include parameters such as area of expertise of company, area of operation of working, number of sub-branches, location of offices. Further, the log in request may be received from an electronic computing device such as a smartphone, a tablet, a desktop, a laptop, though other devices may be used too.

Further, at 1104, the method 1100 may include a step of receiving employee details using the communication device from the user device. Further, the employee details may include personal details of the employee containing the information such as employee's last name, employee's first name, employee's date of birth, employee's aliases (if any), and so on. Further, the employee details may include professional details containing the information such as employee's dates of job assignment, employee's responsibilities at the previous job, location of job assignment, profile of the job, leadership and management skills of the employee and so on. Further, the employee details may include other miscellaneous details such as terms of separation, eligibility of employee for re-hire, notification for resignations by employee, dedication of employee, satisfactory attendance and so on. Further, the employee details may include optional brief review of employee performance

Further, at 1106, the method 1100 may include a step of analyzing, using a processing device, the employee details against existing stored data in the storage device. Further, the user such as the employer may update the information of the employee already stored in the database. Further, the employee details after being updated may include professional details containing the information such as employee dates of job assignment, employee responsibilities, location of job assignment, profile of the job, leadership and management skills of the employee and so on. Further, the employee details may include other miscellaneous details such as terms of separation, eligibility of employee for re-hire, notification for resignations by employee, dedication of employee, satisfactory attendance and so on. Further, the employee details may include optional brief review of employee performance

Further, at 1108, the method 1100 may include a step of storing, using a storage device, an updated employee profile on the basis of analyzing. Further, the information input by the employer, analyzed and may be updated, may be stored in an online universally accessible database, which can be accessed further by one or more other employers for verification purposes.

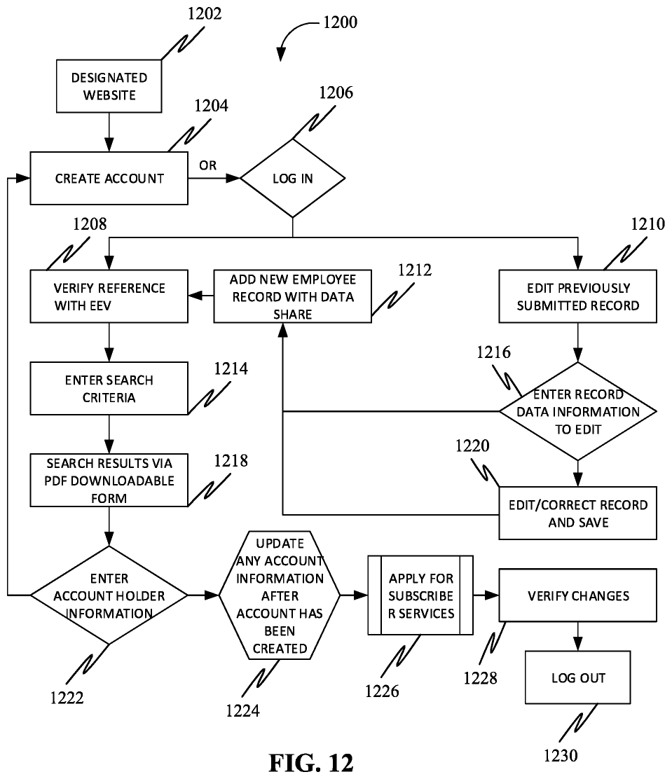

FIG. 12 is a process 1200 facilitating management of employee data, in accordance with some embodiments. Further, the process 1200 may involve prospective employers visiting a designated website 1202, creating login account credentials, verifying an email, uploading required verification documents, and then using an approved subscriber account to access the encrypted database called Recorded Employee Filing System to utilize EEV and Data Share tools via link clicks. A user may create an account at 1204 or may log in at 1206. Further, the user may verify reference with EEV at 1208 or may edit previously submitted record at 1210. Further, the user may enter record data information to edit at 1216. Further, at 1220, the user may edit/correct record and save. Further, at 1212, the user may add new employee record with data share. Further, at 1214, the user may enter search criteria. Further, at 1218, the user may search results via PDF downloadable form. Further, at 1222, the user may enter account holder information. Further, at 1224, the user may update any account information after account has been created. Further, at 1226, the user may apply for subscriber services. Further, at 1228, the user may verify changes. Further, at 1230, the user may log out.

The EEV may be a software application allowing one or more employers to search for employee details, saved in a database. The employers click on the link corresponding to a required. Further the EEV link may open a page that may require the employer to input search criteria, such as the applicant's full name, applicant's date of birth, and so on. Further, the search may generate a document (e.g. a pdf downloadable form) revealing the result of that search. Data Share may be a software application allowing one or more employers to share and validate employee details. If the employer elects to share employee data records, the employer may click on a Data Share link, where a page may open, requiring to enter the details of a record to be shared such as personal details of an applicant containing the information such as applicant's last name, applicant's first name, applicant's date of birth, applicant's aliases (if any), and so on. Further, the search query may include applicant's professional details containing the information such as applicant's dates of job assignment, applicant's responsibilities held at the previous places of work, location of job assignment, profile of the job, leadership and management skills of the applicant and so on. Further, the applicant details may include other miscellaneous details such as terms of separation, eligibility of applicant for re-hire, notification for resignations by applicant, dedication of applicant, satisfactory attendance and so on. Further, the applicant details may include optional brief review of applicant performance.

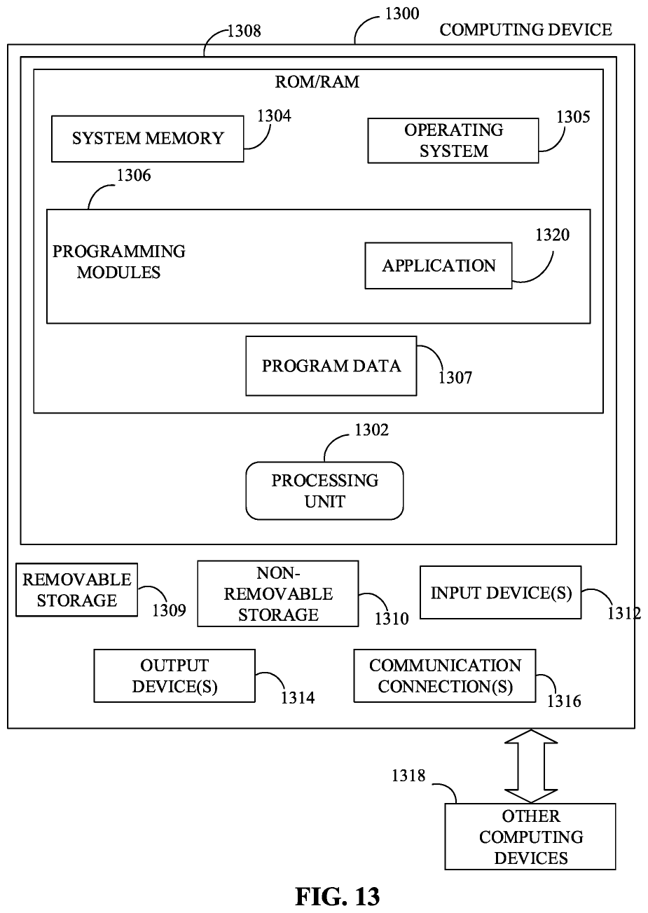

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random-access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300′s operation. In one embodiment, programming modules 1306 may include image-processing module, machine learning module. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and non-volatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, a location sensor, a camera, a biometric sensor, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 (e.g., application 1320 such as a media player) may perform processes including, for example, one or more stages of methods, algorithms, systems, applications, servers, databases as described above. The aforementioned process is an example, and processing unit 1302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating management of employee data, wherein the method comprising:
receiving, using a communication device, a log in request from at least one employee device;
receiving, using the communication device, employee data associated with at least one employee from the at least one employee device;
validating, using a processing device, the employee data by using data retrieved from one or more databases, wherein the one or more databases comprises at least one of government verified databases, educational institution databases, and medical databases and
storing, using a storage device, the employee data in an employee database based on the validating.

2. The method of claim 1, wherein the employee data comprises one or more of personal details, professional details, and miscellaneous details associated with the at least one employee.

3. The method of claim 1, wherein the validating further comprising:
retrieving, using the storage device, at least one relevant data associated with the at least one employee from the one or more databases; and
comparing, using the processing device, the at least one relevant data with the employee data to determine at least one of a match and a discrepancy.

4. The method of claim 3 further comprising transmitting, using the communication device, an alert notification to at least one administrator device if the discrepancy is determined.

5. The method of claim 1 further comprising at least one of:
receiving, using the communication device, a search query from at least one accessing device to access the employee data;
retrieving, using the storage device, the employee data from the employee database based on the search query; and
transmitting, using the communication device, the employee data to the at least one accessing device.

6. The method of claim 1 further comprising storing, using the storage device, the employee data on blockchain based on the validating.

7. The method of claim 6 further comprising at least one of:
receiving, using the communication device, a search query from at least one accessing device to access the employee data;
retrieving, using the storage device, the employee data from the blockchain based on the search query; and
transmitting, using the communication device, the employee data to the at least one accessing device.

8. The method of claim 1 further comprising at least one of:
receiving, using the communication device, an updated employee data associated with the at least one employee from the at least one employee device;
validating, using the processing device, the updated employee data by using data retrieved from the one or more databases; and
updating, using the processing device, the employee database with the updated employee data based on the validating.

9. The method of claim 1 further comprising at least one of:
analyzing, using the processing device, the employee data stored in the database;
generating, using the processing device, insights based on the analyzing; and
transmitting, using the communication device, the insights to at least one administrator device.

10. The method of claim 9, wherein the insights comprise at least one of a cost per hire (CPH), a cost of turnover, a time to fill up a position, and an HR expense factor.

11. A system of facilitating management of employee data, wherein the system comprising:
a communication device configured for:
receiving a log in request from at least one employee device; and
receiving employee data associated with at least one employee from the at least one employee device;
a processing device configured for validating the employee data by using data retrieved from one or more databases, wherein the one or more databases comprises at least one of government verified databases, educational institution databases, and medical databases; and
a storage device configured for storing the employee data in an employee database based on the validating.

12. The system of claim 11, wherein the employee data comprises one or more of personal details, professional details, and miscellaneous details associated with the at least one employee.

13. The system of claim 11, wherein the storage device is further configured for retrieving at least one relevant data associated with the at least one employee from the one or more databases, wherein the processing device is further configured for comparing the at least one relevant data with the employee data to determine at least one of a match and a discrepancy.

14. The system of claim 13, wherein the communication device is further configured for transmitting an alert notification to at least one administrator device if the discrepancy is determined.

15. The system of claim 11, wherein the communication device is further configured for:
receiving a search query from at least one accessing device to access the employee data; and
transmitting the employee data to the at least one accessing device, wherein the storage device is further configured for retrieving the employee data from the employee database based on the search query.

16. The system of claim 11, wherein the storage device is further configured for storing the employee data on blockchain based on the validating.

17. The system of claim 16, wherein the communication device is further configured for:
receiving a search query from at least one accessing device to access the employee data; and,
transmitting the employee data to the at least one accessing device, wherein the storage device is further configured for retrieving the employee data from the blockchain based on the search query.

18. The system of claim 11, wherein the communication device is further configured for receiving an updated employee data associated with the at least one employee from the at least one employee device, wherein the processing device is further configured for:
validating the updated employee data by using data retrieved from the one or more databases; and
updating the employee database with the updated employee data based on the validating.

19. The system of claim 11, wherein the processing device is further configured for:
analyzing the employee data stored in the database; and
generating insights based on the analyzing, wherein the communication device is further configured for transmitting the insights to at least one administrator device.

20. The system of claim 19, wherein the insights comprise at least one of a cost per hire (CPH), a cost of turnover, a time to fill up a position, and an HR expense factor.
